(19) United States
(12) Patent Application Publication
(10) Pub. No.: US 2004/0171322 A1
(43) Pub. Date: Sep. 2, 2004

(54) Rolling mill air permeability film and the manufacturing process and the equipment of air permeability film

(76) Inventors: Jae-Hun Shim, Chungchangnam-do (KR); Soo Young Lee, Kyunggi-do (KR)

Correspondence Address: Charles E Burpee, Warner Norcross & Judd, Suite 900, 111 Lyon Street NW, Grand Rapids, MI, 49503, US

(21) Appl. No.: 10/476,424

(22) PCT Filed: Apr. 20, 2002
(86) PCT No.: PCT/KR02/00734

(30) Foreign Application Priority Data
Apr. 30, 2001 (KR) 2001/23336

(51) Int. Cl. B28B 1/54; B22D 11/01; B22F 9/00; B29B 9/00; B28B 17/00; B29C 67/02; D01D 5/30; D04H 1/00; D04H 3/00; D04H 5/00; D04H 13/00; B32B 27/12

(52) U.S. Cl. 442/76; 442/394; 264/172.11; 425/6; 442/77

(57) ABSTRACT

Disclosed is an air permeable film united with a nonwoven fabric, consisting of a polymer film having an inorganic material extruded to have a basic weight of 35 g/m² or less and united to a partial or whole surface of a nonwoven fabric. The nonwoven fabric having a basic weight of 50 g/m² or less is united to one surface of the extruded polymer film in a melted state, with an air permeable region centering around a drawn mark distributed to the whole surface of a nonwoven fabric-united film rolled and drawn by a press roll. A method of preparing such an air permeable film united with a nonwoven fabric and a device for preparing the same are also described.

### TECHNICAL FIELD

The present invention concerns an air permeable film united with a nonwoven fabric, a method of preparing the same and a device for preparing the same, having the advantages of being used to manufacture inexpensive products at low manufacturing cost due to a simplified preparation equipment and process, and a lowered basic weight (g/m²) of a polymer film.

### PRIOR ART

From the early 1990s, polyethylene type air permeable films have been prepared for use in air permeable and waterproof films. By 1995, the polyethylene type air permeable films had been united with air permeable polypropylene nonwoven fabrics, to obtain another air permeable and waterproof film, whereby such two kinds of air permeable and waterproof films have been mainly used for sanitary products up until now.

The nonwoven fabric, which is soft to the touch, has a tensile strength 1.5 times higher in a longitudinal direction and 3.5 times higher in a transverse direction than such a polyethylene type air permeable film having the same basic weight as that of the nonwoven fabric. So, the nonwoven fabric is applied for manufacture of end products. In particular, the waterproof film composed of the nonwoven fabric and the air permeable film united together have been applied as materials for use in sanitary products of high quality. However, such a film is disadvantageous in light of high preparation cost due to a complicated process.

Research for simultaneously obtaining waterproofness and air permeability only by use of the nonwoven fabric having the advantages as mentioned above has been carried out. But, since such performance of the waterproof film cannot be obtained only using the nonwoven fabric at present, the present invention makes all possible effort to decrease a basic weight (g/m²) of the nonwoven fabric-united film and to simplify a preparation process, thereby economic benefit realizing.

Typically, a drawing device used in preparation of the air permeable film functions to draw the film 1.5 to 2 times by increasing a rate of a drawing roll 1.5 to 2 times in a proceeding direction of the roll upon uniaxial drawing of the film in a longitudinal direction. As such, the drawing roll and the film should be preheated and a cooling roll and a curing roll should be mounted to stabilize physical properties of the drawn film. Therefore, preparation of the nonwoven fabric-united air permeable film according to conventional methods suffers from the disadvantages of expensive preparation equipment, high management cost, complicated process and generation of inferior goods.

Meanwhile, when the air permeable film is subjected to biaxial drawing, more complicated equipment is required. In this regard, an equipment, in addition to the above uniaxial (longitudinal) drawing device, is necessary for leading a transverse drawing by holding the side edges of the film with clips and controlling the gap between the clips to enlarge the width of the film while moving the film in the longitudinal direction, and for heating the film for a biaxial (longitudinal and transverse directional) drawing.

According to such preparation process of conventional nonwoven fabric-united air permeable film, the extruded film is drawn by use of a uniaxial and a biaxial drawing devices, to yield an air permeable film having a basic weight of 18-35 g/m², which is then united with a nonwoven fabric having a basic weight of 15-40 g/m² using an adhesive, such as a hot melt adhesive and a liquid adhesive, or the air permeable film and the nonwoven fabric are thermally adhered by an embossing treatment.

In the case of using such an adhesive, a resultant product feels soft to the touch due to soft nonwoven fabric, but a device configuration and treatment process due to use of the adhesive are complicated. Further, the adhesive may escape to the surface of the nonwoven fabric, thus it is difficult to lower a basic weight of the nonwoven fabric.

Also, in the case of the embossing treatment, such process is relatively simple, but softness of the nonwoven fabric is decreased because the surface of the fabric is heated upon the treatment.

### DISCLOSURE OF THE INVENTION

Accordingly, it is an object of the present invention to provide an inexpensive air permeable film united with a nonwoven fabric, characterized in that an air permeable film is not separately produced before being united with a nonwoven fabric by uniting a polymer film containing an inorganic material which is in a melted state upon extrusion with a nonwoven fabric and drawing a nonwoven fabric-united film in a press roll, to yield the air permeable film united with the nonwoven fabric, thereby reducing a preparation cost and lowering a basic weight of the film.

With a view to providing air permeability to a film, in conventional techniques, pores are formed as a small opening passing air and moisture but not passing water to an interface between the polymer resin and the inorganic material particle drawn together by a conventional drawing process. Meanwhile, in the present invention, an air permeable region is formed from a drawn mark by partially drawing the nonwoven fabric-united film in the press roll with a certain pattern (embossing protrusions). So, the inventive nonwoven fabric-united film can have thinner thickness than conventional films.

It is another object of the present invention to provide a method of preparing such an air permeable film united with a nonwoven fabric, having the advantage of low preparation cost by alleviating problems related with complicated drawing and uniting processes and intricate equipment, in which the nonwoven fabric is united with a polymer film containing an inorganic material in a melted state following extrusion of the polymer film, and the nonwoven fabric-united film is subsequently drawn using the press roll, simply providing air permeability to the film, without use of additional means for performing a drawing or a uniting process.

It is a further object of the present invention to provide a device for preparing such an air permeable film united with a nonwoven fabric.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows a configuration of a device of the present invention.

FIG. 2 shows a lateral view of a press roll of the present invention.

FIG. 3 shows an enlarged, partial cross-sectional view of a draw pattern roll in a press roll of the present invention.

FIG. 4 shows a plan view of the draw pattern roll of FIG. 3.

FIG. 5 shows a plan view of an air permeable film united with a nonwoven fabric of the present invention.

FIG. 6 shows a cross-sectional view of an air permeable film united with a nonwoven fabric of the present invention.

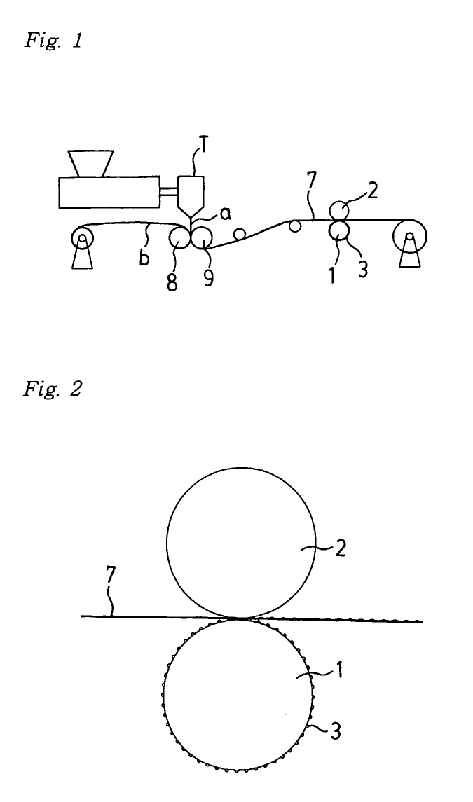

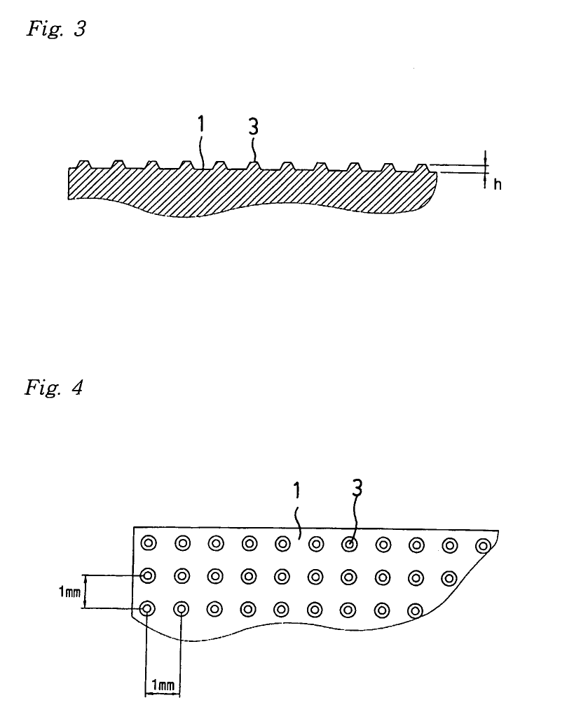

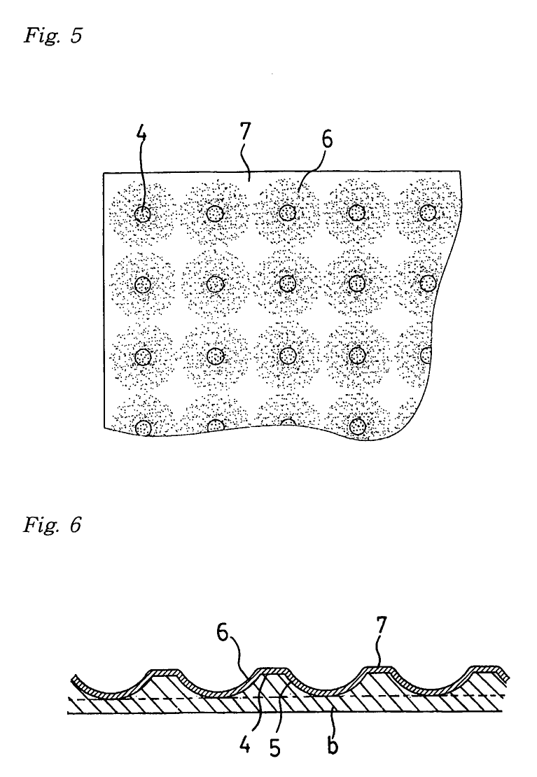

### BEST MODES FOR CARRYING OUT THE INVENTION

According to the present invention, a description will be given of a usable non-woven fabric, a preparation of a polymer compound containing an inorganic material, a preparation of a compound film containing an inorganic material, a preparation of a non-woven fabric-united film and a process of providing air permeability to a non-woven fabric-united film, below.

1) Usable Non-Woven Fabric

Examples of non-woven fabrics usable in the present invention include polypropylene spun bond-, polypropylene melt blown-, polypropylene spun bond-combined melt blown-, polypropylene thermal bond-, nylon type-, polyester type-, polypropylene and polyethylene bicomponent-, and viscose type-nonwoven fabrics. Also, nonwoven fabrics which are formed from a mixture of original yams of the above materials may be used. In the present invention, it is desirable that the nonwoven fabric is not subjected to surface treatment by a hydrophobic agent or a water repellent. The reason for this is that such surface treatment lowers strength of the nonwoven fabric and an inorganic material-containing film united together. Of the nonwoven fabrics as mentioned above, polypropylene spun bond nonwoven fabric, and polypropylene spun bond-combined melt blown nonwoven fabric, which are not subjected to surface treatment, are most preferable, in consideration of cost, physical properties and quality.

2) Preparation of Compound of Polymer Containing Inorganic Material

In the present invention, a polymer resin is uniformly mixed with an inorganic material. The used polymer is exemplified by polyolefin based polymers, such as polyethylene, polypropylene and so on; copolymers of olefin based monomers; and copolymers of olefin based monomers and polar group-containing monomers. As such, the polymer has a melting point below 180° C. As the inorganic material, use is made of calcium carbonate, barium sulfate, SiO₂, TiO₂, zeolite, elvan, talc, and clay. Of them, calcium carbonate is most preferable, considering air permeability, processiblity and compatibility with polyethylene. Moreover, SiO₂ or other infra red radiation materials can be used as the inorganic material in order to provide infra red radiation performance to the film. When the polymer having a melting point of 100-180° C. is used, the inorganic material can be used in the amount of 20-80 parts by weight, on the basis of 20-80 parts by weight of such polymer. As for a mixer used in mixing the polymer and the inorganic material, a twin screw extruder is used in terms of good dispersibility and low oxidation. Upon mixing, the twin screw extruder is held in the temperature range of 180-250° C., and an antioxidant and a dispersant may be additionally added to a mixture of the polymer and the inorganic material.

3) Preparation of Inorganic Material-Containing Compound Film

The inorganic material-containing compound is melted in a single extruder and formed to a film in a melted state in a T-die. Upon film formation, temperature of the T-die is controlled in the range of 100-350° C. so that temperature of the melted film ranges from 170 to 300° C.

4) Preparation of Nonwoven Fabric-United Film

The polyolefin based material containing the inorganic material, suitable for use in preparation of an air permeable film, is melted at 170-300° C. and extruded to the film (a) having a basic weight of 5-35 g/m² through the T-die. While such extruded film (a) in a melt state is fed to a uniting roll comprising a cooling roll 8 and a rubber mangle 9, the polypropylene based nonwoven fabric (b) having a basic weight of 5-50 g/m² is also fed to the uniting roll and united together with the film. As such, the polymer film in a semi-melted state is infiltrated to the nonwoven fabric and then cooled, thereby yielding a united body.

Since the nonwoven fabric is higher in strength, compared to the polymer film, the inventive polyolefin based film containing the inorganic material can be thinly extruded to have a basic weight of 10 g/m², and then united to a portion of the nonwoven fabric.

On the other hand, in conventional off-line methods of manufacturing an air permeable film united with the nonwoven fabric, it is difficult to reduce a basic weight of such a film to 10 g/m². So, even though the film is prepared, a uniting process cannot be performed due to insufficient film strength. By such a restriction, nonwoven fabric-united films with a basic weight of 20 g/m² have been typically used as an air permeable film. However, in the present invention, the thickness of the film united to the nonwoven fabric is drastically reduced, whereby the air permeable and waterproof film united with the nonwoven fabric can be inexpensively prepared.

Also, if necessary, the polymer film may be extruded and united to a partial portion of the nonwoven fabric of wide width. In this regard, the polymer film having a width of 230 mm can be united to the center portion of the nonwoven fabric having a width of 325 mm.

5) Process of Providing Air Permeability to Nonwoven Fabric-United Film

The nonwoven fabric-united film is fed between a draw pattern roll 1 and an elastic roll 2 constituting a press roll, thereby providing air permeability to the film.

In the present invention, the press roll is installed to a line for uniting the nonwoven fabric and the polymer film, whereby air permeability can be provided to the film united with the nonwoven fabric by such a simple apparatus.

The present invention is more specifically described as follows.

The nonwoven fabric-united polymer film containing the inorganic material is prepared by mixing the polymer having a melting point of 100-250° C. with 10-70 parts by weight of the inorganic material.

To 50 parts by weight of polyethylene, 50 parts by weight of calcium carbonate are added and heated to cycles of 170, 180, 200, 220 and 210° C. in a twin screw extruder, to prepare a polymer compound having uniformly distributed inorganic material, which is then melted and extruded in the T-die, yielding the inorganic material-containing polymer film.

The press roll is composed of the draw pattern roll 1 and the elastic roll 2. As for the draw pattern roll 1, draw patterns 3 projected on the surface of the roll are densely arranged. The elastic roll 2 is a rubber type mangle having elastic surface for receiving the projected draw patterns 3. The draw patterns 3 can be replaced with embossing projections provided on an embossing roll. The pressure upon contact of two rolls 1 and 2 for rolling is controlled in the range of 20 kg/cm² by a hydraulic mechanism. Driving force sources of two rolls 1 and 2 are connected to each other so that two rolls are rotated in an engaged state, whereby the nonwoven fabric (b)-united polymer film containing the inorganic material can be rolled between two rolls 1 and 2.

When the nonwoven fabric-united polymer film containing the inorganic material is rolled by the press roll, drawn marks 4 are formed onto the film. Upon rolling, a region of the drawn mark 4 of the film is expanded, thus an air permeable region 6 centering around the drawn mark 4 is obtained. Such an air permeable region 6 is densely distributed on the whole surface of the film, thereby yielding the air permeable film.

A drawing and rolling operation of the polymer film may be performed with the use of a draw pattern-forming body installed to a cooling steel roll.

Such draw patterns comprise a circular shape, a linear shape or other shapes. The draw pattern 3 protruded on the roll surface is treated so as to have blunt tips. Hence, the film is not damaged in a marking process of the draw pattern. By repeating the rolling process, air permeability can be increased.

Upon drawing by the press roll, the polymer film or the nonwoven fabric may be positioned toward the elastic roll.

Having generally described this invention, a further understanding can be obtained by reference to certain specific examples which are provided herein for purposes of illustration only and are not intended to be limiting unless otherwise specified.

### EXAMPLE 1

50 parts by weight of low density polyethylene were added with 50 parts by weight of calcium carbonate, and heated to cycles of 170, 180, 200, 220 and 210° C. in a twin screw extruder, to prepare a polymer having uniformly distributed inorganic material.

The polymer having inorganic material was melted in the extruder heated to cycles of 160, 180, 210, 230 and 220° C., and formed to a film having a basic weight of 15 g/m² at a line speed of 50 m/min through a T-die.

Upon cooling of the film by the cooling roll, a rubber mangle disposed oppositely to the cooling roll was set to apply a pressure of 10 kg/cm², and a polypropylene spun bond-nonwoven fabric having a basic weight of 18 g/m² was fed between the cooling roll and the rubber mangle to unite the nonwoven fabric to the melted polymer film. Subsequently, the nonwoven fabric-united polymer film was provided between a draw pattern roll 1 arranged by projecting peripherally draw patterns 3 having a spacing of 1 mm and a height (h) of 0.5 mm, and an elastic roll 2 applied with a pressure of 50 kg/cm² and having a line speed of 50 m/min. As such, the nonwoven fabric was positioned toward the draw pattern roll 1 upon rolling of the nonwoven film united film.

Thereby, an air permeable region centering around the drawn mark 4 was distributed to the whole surface of the film, yielding a nonwoven fabric-united film with air permeability.

### EXAMPLE 2

An air permeable film was prepared in the same manner as in the above example 1, except that a polymer film having a basic weight of 10 g/m² was prepared.

### EXAMPLE 3

The polymer film containing the inorganic material before being subjected to rolling and drawing, obtained from the above example 1, was provided as a test material.

### EXAMPLE 4

An air permeable film was prepared by once more rolling the film of the above example 1 under the same conditions as in the above example 1.

### EXAMPLE 5

An air permeable film was prepared in the same manner as in the above example 1, except that a polymer film having a width of 230 mm was extruded and united to the center portion of a nonwoven fabric having a width of 325 mm.

Air permeability of the air permeable films was represented by moisture according to ASTM-E96.

The results are shown in Table 1, below.

TABLE 1

| Ex. No. | Moisture Permeability (g/m² · day) (ASTM-E96) |
|---|---|
| 1 | 475 |
| 2 | 615 |
| 3 | 45 |
| 4 | 840 |

From the above result, it can be seen that the films of the examples 1, 2 and 4 have moisture permeability suitable for practical use by a rolling process. When the formed film is decreased in its basic weight, moisture permeability becomes higher. Additionally, repeated rolling process results in higher moisture permeability.

### Industrial Applicability

According to the present invention, while not separately providing a complicated uniting device and a drawing device, an inorganic material distributed polymer film in a melted state can be united with a nonwoven fabric upon extrusion, and rolled by a press roll having a draw pattern roll, whereby an air permeable region is formed, centering around the drawn mark, on the film. Such an air permeable region is distributed to the whole surface of the film, thus air permeability can be provided to a nonwoven fabric-united product. Further, a manufacturing device is simplified and also a basic weight of the nonwoven fabric-united film is drastically decreased, obtaining inexpensive air permeable film united with nonwoven fabric.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

1. An air permeable film united with a nonwoven fabric, comprising
a polymer film containing an inorganic material for use in preparation of an air permeable film, extruded to have a basic weight of 5-35 g/m² and united to a partial or a whole surface of the nonwoven fabric;
the nonwoven fabric having a basic weight of 5-50 g/m², united to one surface of the extruded polymer film in a melted state; and
an air permeable region centering around a drawn mark formed on a nonwoven fabric-united film rolled and drawn by a press roll,
wherein the air permeable region is distributed to the whole surface of the film.

2. A device for preparing an air permeable film united with a nonwoven fabric, comprising
an extruder for extruding a polymer containing an inorganic material for use in preparation of an air permeable film to a polymer film with a basic weight of 5-35 g/m²;
a uniting roll for uniting the nonwoven fabric with a basic weight of 5-50 g/m² to one surface of the extruded polymer film in a melted state; and
a press roll for rolling a nonwoven fabric-united film,
wherein the press roll comprises a draw pattern roll for forming an air permeable region centering around a drawn mark on the nonwoven fabric-united polymer film containing the inorganic material, and an elastic roll closely contacted to the draw pattern roll under pressure and rotated with the draw pattern roll for aiding a rolling of the nonwoven fabric-united polymer film containing the inorganic material.

3. A method of preparing an air permeable film united with a nonwoven fabric, comprising the following steps of:
extruding a polymer with an inorganic material for use in preparation of an air permeable film to have a basic weight of 5-35 g/m² by use of an extruder, to prepare a polymer film;
uniting the nonwoven fabric with a basic weight of 5-50 g/m² to one surface of the extruded polymer film in a melted state; and
rolling and drawing the nonwoven fabric-united polymer film containing an inorganic material by a press roll consisting of a draw pattern roll and an elastic roll, to distribute an air permeable region centering around a drawn mark on the whole surface of the film.
